(19) United States
(12) Patent Application Publication
(10) Pub. No.: US 2020/0301764 A1
(43) Pub. Date: Sep. 24, 2020

(54) OPERATING SYSTEM ON A COMPUTING SYSTEM

(71) Applicant: SCRRD, Inc., Seattle, WA (US)

(72) Inventors: Lucas Kane Thoresen, Seattle, WA (US); Joshua Ian Cohen, Seattle, WA (US); Jason Lucas, Renton, WA (US)

(21) Appl. No.: 16/898,178

(22) Filed: Jun. 10, 2020

Related U.S. Application Data
(63) Continuation-in-part of application No. PCT/US2019/028817, filed on Apr. 23, 2019.
(60) Provisional application No. 62/859,504, filed on Jun. 10, 2019.
(60) Provisional application No. 62/661,570, filed on Apr. 23, 2018.

(51) Int. Cl. G06F 9/54; G06F 9/455; G06F 3/0488

(52) U.S. Cl. CPC G06F 9/542; G06F 9/45558; G06F 2009/4557; G06F 2009/45579; G06F 3/04886

(57) ABSTRACT

An operating system on a computing system is disclosed. In one embodiment, a hypervisor is provided having a hypervised workspace and a native interface to control an underlying portion of the operating system including a system space and a hardware space. A bus accepts a call from the hypervised workspace and dispatches an event for processing. A system space arbiter is interposed between the hypervised workspace and the system space and, similarly, a hardware spaced arbiter is interposed between the system space and the hardware space. Each of the native interface, system space arbiter, and the hardware space arbiter are configured to intercept the dispatched event for authentication and context check. The system presented here uses distributed census algorithms and domain rings for maintaining fault-tolerant storage, including ledgers of security transactions, so that administrators have both internal and external security perspectives outside of the structure and design.

### PRIORITY STATEMENT & CROSS-REFERENCE TO RELATED APPLICATIONS

This application claims priority from co-pending U.S. Patent Application Ser. No. 62/859,504 entitled “Operating System on a Computing System” and filed on Jun. 10, 2019, in the names of Joshua Ian Cohen et al.; which is hereby incorporated by reference, in entirety, for all purposes. This application is also a regular national application filed under 35 U.S.C. § 1.111(a) claiming priority under 35 U.S.C. § 120 of the Apr. 23, 2019 filing date of co-pending International Application Serial No. PCT/US2019/028817, which designates the United States, filed in the names of Joshua Ian Cohen et al. and entitled “Operating System on a Computing System;” which claims priority from U.S. Patent Application Ser. No. 62/661,570 entitled “Nebula Operating System” and filed on Apr. 23, 2018, in the names of Lucas Thoresen et al; both of which are hereby incorporated by reference, in entirety, for all purposes.

### TECHNICAL FIELD OF THE INVENTION

This invention relates, in general, to operating systems on a computing system and, in particular, to enhanced performance in operating systems and methods for managing computer hardware and software resources providing support for common services for computer programs.

### BACKGROUND OF THE INVENTION

With respect to operating systems, a hypervisor allows multiple operating systems to run side-by-side on a host computer at the same time and provides each hypervised operating system with a set of virtual resources. These virtual resources provide each operating system a portion of the actual resources of the computer. Using a hypervisor, the distribution of computer resources within a single computer makes the computer appear to function as if it were two or more independent computers. Utilizing a hypervisor will allow multiple operating system instances to run on the host computer. This however, does have drawbacks. The administrative overhead required to operate the hypervisor reduces the overall computer resources available for running operating systems and applications. As a result of high administrative overhead and other issues, there is a need for improved hypervisors.

### SUMMARY OF THE INVENTION

It would be advantageous to achieve systems and methods for providing operating systems on computing systems that would improve upon existing limitations in functionality. It would be desirable to enable an operating system architecture-based solution leveraging hardware that would provide enhanced hypervision services in a wide variety of hardware systems and applications. To better address one or more of these concerns, an operating system for a computing system and methods for use of the same are disclosed.

In one embodiment of the operating system on a computing system, a hypervisor is provided having a hypervised workspace and a native interface to control an underlying portion of the operating system. Native calls are placed on a dividing bus and dispatched from the hypervised workspace layer down to the layers beneath. A virtual space, system space, and hardware space arbiter are interposed between the respective layers from the hypervised layer down to a boot-space or a pre-boot layer. As an example, a hardware spaced arbiter is interposed between the system space and the boot space. Each of the arbiters, including the hardware space arbiter, are configured to intercept the dispatched events and perform authentication and context checking. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a conceptual model that characterizes and standardizes communication functions within a computing system including one embodiment of an operating system according to the teachings presented herein;

FIG. 2 is a further conceptual model that characterizes and standardizes communication functions within the computing system depicted in FIG. 1 in additional detail;

FIG. 3 is a conceptual model that characterizes and standardizes communication functions within the pre-boot layer of the computing system depicted in FIG. 1 in additional detail;

FIG. 4 is a schematic diagram of one embodiment of a decryption key utilized by the operating system within the computing system;

FIG. 5 is a schematic diagram of one embodiment of key requests utilized by the operating system within the computing system;

FIG. 6 is a schematic diagram of one embodiment of key shard utilization employed by the operating system within the computing system; and

FIG. 7 is a conceptual model that characterizes and standardizes particular communication functions within the pre-boot layer of the computing system depicted in FIG. 1 in additional detail.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

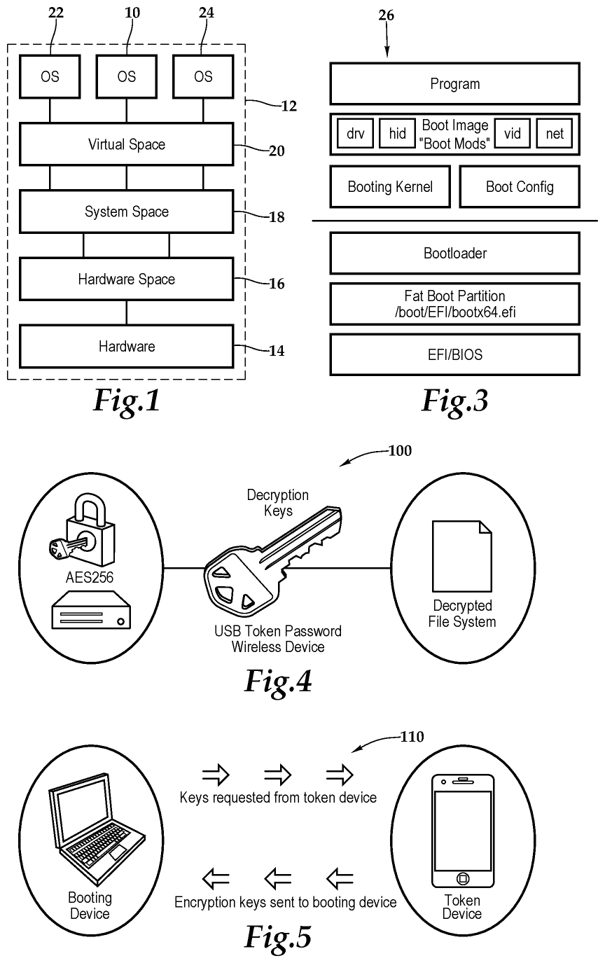

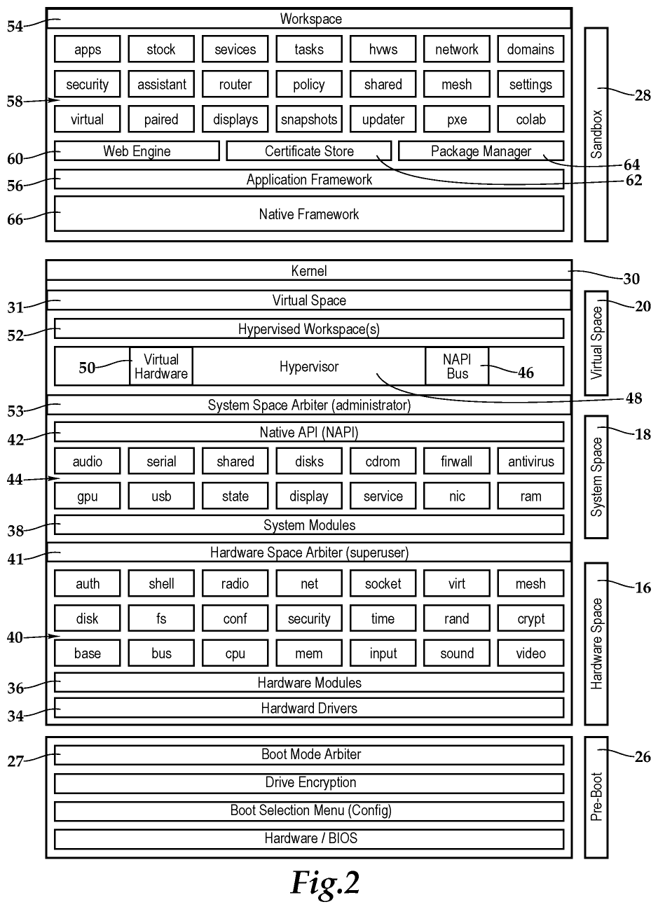

Referring initially to FIG. 1 and FIG. 2, therein is depicted one embodiment of an operating system that is conceptually illustrated and generally designated 10. The operating system 10 resides on a computing system which includes a hardware layer 14, a hardware space layer 16, a system space layer 18, a virtual space layer 20, and instances of other operating systems 22, 24. The operating system 10 may be a desktop or mobile operating system that allows users to run as much software from existing platforms as possible. The operating system 10 provides the unique ability to run multiple hardware-accelerated operating systems simultaneously, such as operating systems 22, 24. A pre-boot layer 26 is below the hardware space layer 14 and a sandbox layer 28 is above the virtual space layer 20. As shown, in one embodiment, a kernel 30 having a virtual space 31 has a built-in hypervisor feature called a hypervised workspace 52 (HVWS 52) that allows users to install other common operating systems along-side the operating system 10, without dual-booting, in order to run software from other platforms, such as productivity suites, games, or browsers, for example.

Another important aspect of the operating system 10 is its awareness of devices in the area and inclusion of a wireless mesh networking with distributed consensus in its design. Machines interconnect with other machines in a distributed, peer-to-peer fashion that allows for the creation of domains and sharing of computing resources. This can happen over the Internet, on the other side of the world, over the mesh, or on a LAN. A network boot PXE installer may also be utilized to further share the operating system 10 with neighboring users. A combination of an installer and third-party programs may provide this extension.

The operating system 10 may create virtual LANs that multiple HVWSs 52 may share. This allows users to create domains with shared resource pools and have the other machines on the network agree upon the state of the domain and pools. Virtual LAN adapters are also used in mesh networking, and the distributed protocol, which means that the machines will reach consensus about shared and encrypted resources without the need for inter-office VPN bridges.

With respect to the pre-boot layer 26, this portion of the computing system 12 lies outside the operating system 10, yet it is extremely important to a workstation utilizing the operating system 10. As long as the bootloader remains intact and cryptographically secure, then it will be difficult for a modified bootloader to steal the user's boot password without bypassing additional security and integrity checks. The pre-boot code is responsible for the initial invocation of the kernel 30, and for decryption of the system partition, which gives the operating system 12 protection against outside attack. The operating system 12 will verify the integrity of the bootloader, that it matches a known-good loader's SHA256 checksum, for example. Each additional boot token may store a copy of the checksum for the purpose of verification from an external perspective as shown in FIG. 3, which depicts one operational configuration and embodiment of the pre-boot layer 26.

Returning to FIG. 1 and FIG. 2, in one embodiment, a loader sits directly after the Master Boot Record (MBR) and is invoked by the BIOS or UEFI of the user's mainboard. Ideally both the extensible firmware interfaces and traditional BIOS boot code should be implemented. For maximum compatibility with desktops, laptops, and phones, additional loader code may be required on a vendor-by-vendor basis. This is the first real program that is executed by the system.

A configuration store (Config) within the pre-boot layer 26 is a human-readable database that maintains records of the system for the purpose of integrity. At the time of install, the database is populated with the machines original or factory configuration, including the unique identifiers (serial numbers) of the drives, motherboard, BIOS/EFI version info, and any removable devices. Checksums of the boot block and any EFI bootable binaries stored in/boot/EFI for integrity, and in general, an account of the system as it was first installed. At the time of boot, part of the bootloader's responsibility is to warn the user when the configuration has changed, coloring anything that is changed in RED.

Snapshots are updated in the last boot section of the config, which houses the same info from the previous boot. Bootloader configs can be persisted on removable tokens for extra security.

The status of the config store validates:
What drives are plugged into each SATA port or other interface on the board, and that their positions have not changed.
Other hardware changes since install and last boot.
The status of the boot image, and that it is not corrupted.
A list of valid boot tokens.
The status of the previous boot, a timestamp, and whether or not it was a success.
Existing horizontal boot options. (Is there a new OS or EFI image?)
What HID (Human Input Devices) are present at boot. (For example, there may be a generic driver for a keyboard, but for some reason there are multiple keyboards plugged in that the user did not know about.)

As its name suggests, the config store also houses configuration parameters and flags that are to be passed to the running kernel, the booting kernel derives its configuration from the signed boot image. Up-chain signing can be used to verify the integrity of the boot process provided that the base itself is signed. Each privilege tier layer may save checksums for binary programs The user possesses a set of keys that they can use to sign their own software for the booting layer, and each module is listed in the bootloader against the config for the user to see that it has or has not loaded.

A detection process accounts for hardware and software on the system to detail in the config. Besides additional operating systems being defined in the boot.conf, most operating systems can be detected by looking for BootX, Grub, LiLo, and the Windows Loader on existing internal and external storage devices. The point is users have the option of installing the operating system alongside another operating system if they so choose. The bootloader uses automatic detection, to allow for the booting of other operating systems, or the user can make manual bootloader edits in the configuration hive. Additionally, on EFI machines implementing the UEFI standard, the user has the option of dropping into the EFI Shell, which raises visibility of EFI boot programs and protocols, as well as managing existing EFI programs and partitions. Any boot/EFI partitions and any compiled EFI binaries that could reasonably be booted by the system should be listed there.

With respect to authentication, in one implementation, a unique feature of the operating system 10 is the ability to use a mobile device, or other IoT device, as a secondary factor in unlocking encrypted drives. This allows users to encrypt their drives, and unlock them with their phones, and an optional secondary factor (2FA) password or flash token. This technique provides data integrity, as in, the bits on the encrypted portion of the disk cannot be altered in a meaningful way, without knowledge of the encryption keys. It also provides data privacy, that is, if an adversary were to remove your hard drive, and analyze the data with an external hard drive dock, they would need the decryption keys in order to recover sensitive files.

The authentication component of the bootloader uses drivers from the boot image, which is a collection of Boot Mods that can optionally be exported by the operating system drivers and were installed with prior authorization from a boot mode arbiter 27. This layer represents the highest privilege tier (ring 0) on the system. The collection of drivers might include disk drivers and even network for the purpose of wireless secondary factor authentication, where the token device uses asymmetric encryption to sign a message containing part of the keys to the booting device, or to request a TOTP token (password that changes with time) from the user's device in an automated fashion. Unless a network is specifically required at the boot layer, network-aware drivers are forbidden and/or disabled by default. However, it should be noted that the EFI standard itself supports network, and it may be relevant to embed parts of this process into an EFI program on EFI systems with the system structure:

### Boot Space->Hardware Space->System Space->Virtual Space->Workspace

Both of these aspects, data integrity and privacy, work to enhance the overall security of the operating system 10 installation. This yields an operating system that may be impervious to many physical attacks designed to steal data from your hard drive. If the bootloader is replaced, then the signatures will not match after the drive is unlocked, nor will the signature match others in the domain. Since the memory modules could be removed in an evil-maiden style attack, keys should be encrypted in memory and scattered across the physical RAM sticks. This means that the time that the attacker has to recover the keys is reduced as they need to collect key fragments successfully from multiple RAM sticks at random offsets as depicted by encryption keys 100 in FIG. 4. Machines utilizing the operating system 10 will come to consensus about domain objects and keys by pairing off into manageably-sized pockets, where each pocket might elect a leader to participate in inter-pocket consensus elections for deciding the validity of information at the global level. Many distributed consensus algorithms rely on a significant amount of cross-communication between nodes, and so pockets and domains help to break the problem down into sizable pieces so that there is not this problem of way too much network traffic.

Returning to FIG. 1 and FIG. 2, with respect to an unlocking mechanism, the bootloader allows for the decryption of the encrypted hard drives in multiple different fashions. The user has the option to remember a password, use an external boot token, or pair a wireless device in order to unlock their hard drive. These options might include the use of multiple layered or interlaced encryption ciphers, including the Blowfish block cipher, AES, and Anubis, in order to encrypt partitions. In order to decrypt these partitions, the user can select from multiple methods, including typing a plain password, in order to start the machine.

If the user chooses to use password authentication to unlock their hard drive, the password will be salted, and digested by the SHA algorithm, which will produce a 256-bit encryption key that will be used in a PBKDF2 or other key derivation algorithm. The encryption key is used to unlock the primary disk, as well as other encrypted drives that happen to use the same key. The salt is derived from the current system timestamp, the nanotime, which comes from the motherboard CMOS clock. The value may also come from cryptographic hardware, such as a TPM chip, the Trusted Platform Module, which serves to store cryptographic keys and certificates, and uses certain cryptographic operations on many newer boxes that happen to have this hardware. If the hardware is present, the option to store parts of encryption keys in the TPM should also be present.

Specifically also, the certificates for signed bootloader can also be stored here or registered with UEFI as user keys. The user should have the option to clear these keys from within the bootloader. The salt can be stored in the header of the encrypted disk, as it is one piece of information that is required to decrypt the primary partition that is not secret, the purpose of the salt is to prevent the usage of rainbow tables in cracking the encryption keys, as unique tables would have to be generated for each salted password separately. The user also has the option to use their smartphone to unlock encrypted hard drives. This means that the user's phone contains part of the block cipher encryption keys require to unlock the disk. The phone must implement the same protocol as the operating system, and might also be running the operating system 10, but this is not required if the user chooses to use an authenticator app that emits network frames. The authenticator app, or ‘platform application’, has a public/private keypair that is known and trusted to the operating system's bootloader, and is seeded with a cryptographically-secure random number generator (RNG).

While encrypting a partition, the user has the option to specify the key fingerprints of devices that will be used to unlock the hard drive, via a pairing process, and any key shards or temporal seeds are loaded onto the device by means of NFC, IR, QR codes, WiFi, Bluetooth, other networking, or manual typing. This pairing process involves comparing codes on both devices. The token device may save an encrypted copy of the hard drive key fragment, after receiving it over WiFi or Bluetooth.

When the user wishes to unlock their hard drive, they simply bring the token device within range of the booting device, and a dialog will pop up on the token device's screen, asking for an optional code, before the drive key is sent back to the booting machine. The booting device asks for the token device by its identifier, and the token device responds with a cryptographically signed message, boot_ok, and boot_key_shard, back to the booting device as shown by key flow 110 in FIG. 5.

Returning to FIG. 1 and FIG. 2, the operating system 10 includes a bootloader utilizing multiple techniques to protect user data. One technique is known as on-the-fly decryption, which means that the loader will be decrypting hard disk sectors block-by-block (on-demand) instead of all at once. This allows the operating system 10 to be mounted and run from inside the encrypted layer, maintaining that any written data is encrypted, that any read data is decrypted, and that any decrypted data is kept in working memory or volatile caches until it is no longer needed. On-the-fly encryption and decryption is common in the art of disk encryption software, and is applied here to provide another layer of security that protects data privacy and integrity. The Nebula approach is to logically structure the operating system to have the most top-down and bottom-up resilience against common attack vectors, and to provide the user with total visibility into their system so that they can see both how it works, and that nothing is hiding there. The problem with extra support for more ciphers and entropy seeding algorithms like BBS (BlumBlumShub quadratic residue generator), is that the must be available at the lower layers to unlock the disk, which is one to separate the boot and pre-boot layers. In the security suite, Blowfish, Anubis, SHA-1/256/3 a Whirlpool, RSA and DSA are among the ciphers more specifically used in locking and unlocking the disk. During initial encryption, from the inside the operating system 10 itself, or the installation program, the user's password is turned into a hash. The password is converted into a salted hash, with a nanosecond timestamp, and hardware id combo:

Sha256 (salt, password, iterations, nanotime, length):
79ff5365c8d92f503bb34eab1de9bf7fe505d1c091b4d8c2ac9e6cfd89b f94eb

The block cipher that the drive is encrypted to should be peer-reviewed and audited in order to protect consumer privacy. In addition, the drive encryption source code, should be made publicly available. (to instill confidence in a peer-reviewed crypto system) This is because crypto is best peer-reviewed, and not home brewed. Some notable block ciphers include, AES, Two-Fish, Serpent, and Blowfish. (In both CBC and XTS modes) Notable hashing algorithms include SHA 256 and Blowflish and would be suitable for this purpose.

After the system disk has been unlocked by the bootloader, the keys in memory must be protected, in order to thwart against cold-boot attacks. During a cold-boot attack, an attacker might sever a target computer's power, extract its memory modules, and recover the encryption keys with an external card reader. Typically, this is done at stabilized temperature. The problem is that the bits on a RAM module aren't erased immediately after power is severed, and there may be no good way to erase sensitive memory without a BIOS-level feature that wipes the modules while the system has power.

The bits on the memory sticks themselves degrade more slowly when exposed to freezing temperatures, and ordinarily hold the disk encryption keys. Thwarting these attacks will mean making the keys unrecoverable to the adversary.

The approach of the operating system 10 may involve encrypting keys in memory and scattering them across multiple physical RAM modules to reduce the chances of a successful key recovery. At each boot, the bootloader program selects new random offset for the keys, which are stored in a memory page inside the kernel's memory that is also at a random location. This makes it so the attacker first has to locate the page containing the offset information, and then read from each of the offset points to get the complete keys, thereby increasing the complexity will make these attacks a little bit more difficult and give those bits some time to degrade.

The kernel 30 and encrypted bootloader will thwart many types of memory extraction techniques by storing encryption keys in randomized memory locations, with memory decoy pointers, and additional plausible pointers that further impede key recovery. Besides memory randomization, the operating system 10 uses a technique first known as TRESOR, which stands for “TRESOR Runs Encryption Securely Outside RAM”, for secure kernel-protected key storage in the x64 CPU registers themselves.

The components required to perform in-CPU register storage of the encryption keys can be loaded into the kernel 30 from within boot space. This is the most privileged part of the system where applications are allowed to flash hardware and make changes to drivers. Since the operating system users should not log into hardware space or system space directly, developers can perform privileged operations in hardware space through a hardware space arbiter 41. However, accessing boot space requires that hardware space driver modules export boot mods that are copied into a boot image at the time that the kernel 30 is installed, upgraded, or updated. This requires permissions from the boot mode arbiter 27 for ring 0 access to the system.

The hardware space arbiter 41 may pop-up a single or multi-paged dialog detailing the permissions required, and reasons for each permission in summary. The user then has the option to grant or deny these requests, which will determine if the hardware space commands are allowable. The boot space arbiter 41 requires that the user grant permission for their kernel and/or boot image to be modified.

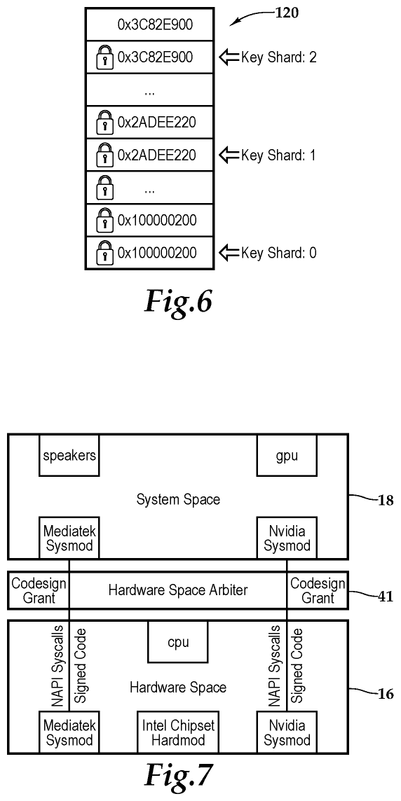

Since these confirmation dialogs arise in a protected part of the operation system 10, other applications will not be able to draw-over or interfere with the privilege elevation process. As users grant privileges to applications, specific privilege groups may be automatically granted in the future, or the users might device to revoke access, which would prevent the application from modifying the base of the operating system 10. The user must break out of the sandbox in order to read from the registers, as shown by key shard implementation 120 in FIG. 6.

Returning to FIG. 1 and FIG. 2, the hardware space layer 16 of the kernel 30 is where the system takes shape. It is also sandboxed from the rest of the kernel 30 and is accessible with the permission of the system owner. Much of the core of the operating system is found in hardware space layer 16. The architecture of the kernel 30 divides system permissions into three major permission categories: hardware permissions, system permissions, and virtual permissions.

With respect to hardware permissions, hardware space represents the lowest components of the kernel 30, and includes the entire base of the operating system, and hardware drivers. Hardware space is required for the system to perform and provides a low-level interface for each piece of hardware connected to the machine.

With respect to system permissions, the ‘system space’ or system abstraction layer, sits on top of the hardware, and provides a virtual interface for each hardware component. This will simplify the understanding of each hardware component, and create a secure base for the hypervisor, that doesn't care about drivers so much as the abstraction of virtual resources to individual virtual machines. For example, there might be two SATA drives attached to the system, and the hardware layer understands one device as an SSD Block device, and the other as a USB Mass Storage Device and is attached to the bus. The hardware layer 14 would identify the USB device separately from the SATA device, yet, the system layer will see each device as a type of disk and offer it to the virtual layers of the operating system 10 that will share disk as a resource.

With respect to virtual permissions, it is important to mention how these layers of the operating system 10 fit together. Virtual space 31 is where virtual machines are nested and utilizes resources from system space. In general, virtual space 31 is where hypervised workspaces 52 are created, sandboxed, and concurrently executed. This means that apps running in separate workspaces cannot interfere with one another. In order to communicate, they must do so with the operating system API.

As shown in FIG. 1, FIG. 2, and FIG. 7, with respect to hardware drivers 34, drivers for the operating system 10 are depicted spanning system and hardware space layer 16. Drivers are an important part of any operating system, especially those designed to run on a plethora of existing hardware in the IoT ecosystem. Another important aspect of any driver is its ability to interact with the hardware layer on a very low-level. The operating system 10 ensures that this capability is available to users with privileged access to the system who can confirm that this is what was intended. The system may even ask the user for their password or secondary factor, (which includes other devices), that will help to validate the presence of an authorized administrator of the system, and not some imposter.

With respect to hardware modules 36, when developers write programs for the operating system 10, they have the digression to specify permissions on an as-needed or initial basis. In the as-needed case, the app asks user for permission when the user performs an action that requires authorization or reauthorization. A callback event fires when the user confirms or dismisses the permissions dialog. The initial case refers to the need to ask for each permission up-front, which may open a similar dialog. The user can see a list of permissions and permissions reasons as stated by the developer, which gives developers an opportunity to explain how the application uses specific permissions. Some low-level modules, more specifically drivers, might request permissions up-front in order to function. Otherwise the operating system won't run them. When modules are installed, there is an auditable list of native application program interface calls that the module is authorized to make, which is something that advanced users can look at to see what the module can do, even if they do not have the source code. These permissions would be specified as part of the application's metadata and would automatically be added under certain circumstances, as the pythonic language may analyze the user's code and build a list of every system and module call. From the list of called methods the compiler may apply a manifest to the metadata of the application. The user can read the manifest for the program, and gain visibility into encountered programs and their capabilities before any execution. Even when the user doesn't know the specifics, a breakdown of the manifest will be available, showing which system resources the program will be allowed to access.

If an application contains a driver, the user will need to re-authenticate in order for the arbiter to grant module installation and linking. The driver may be otherwise be enabled at the time of install. The user may be required to answer low-level system dialog that cannot be drawn over or manipulated by any other program. These dialogs may appear on the screen or be drawn over hypervised workstations. Mind that the dialog is generated by a module beneath the virtual sandbox, and no call that could be made that would dismiss it programmatically without first responding to a similar dialog at some point beforehand. Many drivers will contain hardware modules that define how the operating system 10 should interact with devices. Many system modules 38 will abstract the functionality of these devices for use at the hypervisor level.

In FIG. 2 and FIG. 7, several hardware modules 40 are shown. It is also shown that a hardware module does not require a system module if an abstraction already exists. If the chipset hardware module is for a USB interface, then the operating system 10 already has an understanding of what a USB port is at the system level, and there is no reason to bundle a system module. The hardware module simply specifies that the device is a USB interface, and the USB sysmod provides a default abstraction, and expects certain methods and capabilities to be available.

Also shown, is a hardware module for a video card that includes a sysmod. The operating system 10 already has an understanding of the concept of a ‘gpu’, however, the vendor chose to create an additional sysmod to go above and beyond the ‘gpu’ abstraction. This allows the vendor to offer additional functionality, such as augmented reality rendering, or an independent processing platform like Nvidia's CUDA. Sysmods are important, because they make these resources available to the hypervisor, and thus, to the sandboxed parts of the operating system 10.

Users may have chosen to install a 3rd party OS inside a hypervised workspace 52, so that they may play their favorite games. With access to advanced hardware resources and features, for example an architecture and vendor's driver supporting CUDA or OpenCL graphics features from within the hypervised layer. The vendor might create a hardmod to allow for low-level functionality, and a sysmod, which abstracts the functionality for programs, scheduling, and hypervised workstations. Users should not need to dual-boot in order to play games on the 3rd party platforms, and would instead, prefer to run multiple platforms simultaneously with a hypervised workspace 52. The user could do the same with many kinds of operating systems such as Windows, GNU/Linux, Unix, or MacOS. The true benefit of hypervised workspaces 52 is that each workspace may have hardware acceleration, and that the user is protected from many kinds of common security attacks due to sandboxing and arbitration.

Each guest operating system may require its own drivers, such as a graphics card driver. This is not a problem because the operating system and its hypervisor now understand the hardware. The guest OS will detect the exact model of graphics card, such as “Nvidia GeForce GTX 560TI”, as the layer beneath has hardware passthrough.

The operating system 10, solution is to allow vendors to define modules for the hypervisor and specify which components and features should be exposed to each guest (workspace). It might be the case that some guests don't have proper driver support for proprietary hardware and would prefer a “Standard Graphics Adapter” instead. Users should be able to choose which driver sub-system is used for individual guests, so that the best virtual hardware for the guest is always available. The operating system 10 seeks to create a modular driver framework that lets developers write drivers compatible with virtualization, such that the hardware's driver resources are directly exposed to the virtual machine layer. Virtual machines may schedule hardware usage times, switch contexts, or utilize additional hardware features that vendors design for their hardware. The hypervisor may supply the guest OS with an abstracted adapter.

Even though components in hardware space are running from within the most privileged part of the system besides the booting layer, programs will take on the privileges of the caller. One cannot import these components from user space, and escalate privileges into hardware space, nor can they break outside of the caller's sandbox without a grant from the correct arbiter. Likewise, when modules are imported, they are invoked with the permissions of the importer. Hardware space includes a system base which is broken up into sub-components with several permissions groups. These sub-permissions groups or ‘risk-factors’ further separate what modules in hardware space can and can't do, even though all of the code is run in the most privileged space on the system. The goal is to provide further granularity by risk factor. For example, if a developer was writing a WiFi card driver that interacts with WiFi frames coming from other machines, the developer could mark that there is a risk of the module becoming compromised, and Nebula would isolate the module from others in hardware space. This goes hand-in-hand with the original request from the arbiter to install the module, which identified each method that the module is allowed to call. Without a re-authorization, the module will only be allowed to call those methods that it was installed with. This helps to protect the user from injected or foreign functionality, because the attacker will be limited to those methods. System administrators might go back and view details about each module and remove modules that go outside of their own constraints or policy.

Even though the drivers and code are written in a high-level language with low-level features available, there is still significant risk of logical bugs, malicious firmware updates, unsanitary data, and the like. The benefit of a high-level language is that in-memory attacks become more difficult, and buffers do not overflow in predictable ways, and yet, bugs are always possible. Mitigating buffer overflows system-wide results in a much more secure platform, but will require a huge development undertaking.

If a module tries to access any other module that wasn't explicitly defined by the developer's own signed code, then access would be denied. A common security challenge, is that attackers will often hijack programs, and use them to run their own malicious code. Setting this requirement will mean that the attacker is limited to calling API functions that would only be accessed under ordinary circumstances.

The hardware space layer 16 includes the core system and drivers. The compiler and standard library, are used to build the entire kernel that will form the base for the rest of the system. The structure of the kernel API is designed to be as easy-to-use and possible. Any hardware modules can be written in the Pythonic language, which is simple to follow, and compiled for performance. The core of the operating system 10 needs to include support for the underlying hardware itself. Before many of the hardware drivers can be loaded, the kernel 30 needs to have a basic understanding of each hardware component on the machine's main board.

At the lowest level of hardware space, there is code to handle allocating resources for programs and interactions with the system's BIOS or EFI interface, and for creating file handles (file-like objects) that represent devices, sockets, files, virtual adapters, and otherwise. This is similar to how the Python language handles open-files and sockets, except in the operating system 10, other hardware components are also represented by file-like objects on the low-level. Unlike Linux/Unix, these file handles are not ‘mounted’ in the filesystem, for example on a Linux machine, you might have a hard disk drive “/dev/sda1” that shows up as a file in the filesystem browser or directory listing. In the operating system 10, hardware devices are available from the kernel APIs, and used for the system and fed into the hypervisor with the system-level device abstractions. One would import the correct module, and call a listing method, to get a list of hardware devices in the category.

The ‘base’ module in hardware space allows the system to interact with the motherboard's BIOS (Basic I/O System) or EFI (Extensible Firmware Interface). This might include flashing hardware components, upgrading the system BIOS to a newer version from an update file supplied by the vendor. This is considered to be one of the greatest, if not the greatest, privileges of the operating system, as the permission to flash hardware firmware, allow for changes in layers beneath the operating system 10. The operating system 10 cannot do as good of job protecting the user, if their underlying hardware is damaged, or infected by a malicious firmware update. Typically, many hardware components have their own internal operating systems, which further add to the complexity of securing a computer system.

In addition to flashing, there are also many system related functions that the kernel 30 must handle. This allows programs to subscribe to low-level functions such as a reset or power button presses. The system should be able to interact with certain low-level hardware that might also have a BIOS-level control interface. These components allow the operating system 10 to enumerate hardware, detect the screen, and allocate the initial memory for the kernel 30. There are different kinds of hardware out there, and some proprietary, such as Apple hardware, that has a specific boot-code before it will allow the booting of an operating system. If the operating system 10 intends to run on Apple hardware, and depending on licensing concerns, the boot code might need to be implemented in order for the operating system to boot MacOS in a HVWS. Likewise, if the user has an extensible firmware interface instead of a BIOS, then the boot process differs, and the system must register itself to the EFI in order for the operating system 10 to boot. The easiest way to do this is simply having a FAT partition with a bootable EFI image at “/boot/EFI/” as per the UEFI specification.

The operating system 10 must also know about the what devices are attached to the buses of the motherboard. Various buses exist on a modern motherboard for interfacing with PCI devices, Memory, Drives, and the CPU. The system needs to know about all of these components. In addition to this, some devices attached to these buses, are actually controllers, such as a USB Controller. USB is actually handled separately in a USB module. The USB module needs to know about these primary buses and the hardware addresses of any busses.

On most motherboards, the CPU is connected to the Front Side Bus (FSB), which is connected to the North Bridge. The North and South Bridges communicate over an I/O Controller Hub, which is another kind of bus. The system memory, PCI-E (PCI Express), and AGP video, are all connected to the North Bridge. Finally, the South Bridge is connected to the normal PCI card slots, IDE, SATA, USB, Ethernet, Audio Encoding Chips, and CMOS. On the South Bridge, there is also a Bus for flashing and/or interacting with the BIOS, called the LPC Bus. The LPC bus is connected to Serial and Parallel Ports, Floppy Controllers, and PS/2 input devices like a keyboard or mice. To make matters a bit trickier, USB keyboards and mice are also handled separately by the USB subsystem. LPC stands for “Low Pin Count”.

The operating system 10 stack also requires the ability to interface with hard disk drives and solid-state drives. Although raw data may have come off from a SATA controller that was enumerated by a different part of the operating system, the basic understanding of disks and file systems comes from hardware space. In system space there are abstractions for virtual drives, and in virtual space, there are virtual controllers for each kind of device. Once drives are detected, the operating system 10 keeps representational objects and metadata in memory for programs to access with native application program interface.

In order to mount the filesystems on disks, the operating system 10 needs to have its own implementations of EXT4, both should support as many common filesystems as possible. (Ex: UFS, ZFS, FAT16, FAT32, and NTFS.) The root mount point, on other systems ‘\’ contains the operating system files, and likely be installed on the system partition. Once the root mount point has been mounted, configuration values can be pulled from the disk. The hardware space level configuration store has configuration values for each hardmod that exports its own set of preferences. The operating system 10 has its own unified configuration hive that saves configs for hardmods, sysmods, and apps. In each case, specific permissions are required to read from and write to configs for each type of entry. For example, there might be a hardware tier of configs that corresponds to hardware space, and can only be accessed with the hardware user's permissions. Realistically, in one implementation, these calls would occur through the native application program interface, and the system would prompt the user for re-authentication, before execution. The calls themselves can also be made from inside the virtualization sandbox, so it is important for the system to audit them.

The developer should be able to export configuration values that users can change them with a GUI, TUI, or CLI. (Through the Settings Manager) The system will translate these into human-readable configuration files that are stored in ‘/conf’. Other programs can write their configuration files in ‘/conf’, but the configuration system has APIs for registering and unregistering entries that will appear in the menus for the user. This means developers can write drivers and apps for guest operating systems that unify the operating system experience, and utilize native calls to run programs that need access outside of the virtualization sandbox. This is similar to ‘/etc’ on GNU Linux, or the registry on Microsoft Windows. When you look into it, these are really just a collection of formatted JSON, YAML or otherwise human-readable files stored on the disk. The system includes an index that describes the names of each program, and the configuration files that belong to each.

In one embodiment, the operating system 10 uses features from the Pythonic interpreter along with system environment variables, and a user profile to build shell sessions from the system environment variables and user profiles. This means that the users can run commands at the CLI or textual user session from inside the sandbox. These commands are executed when the correct permissions are met. Some low-level permissions are very scrupulously scoped-out and limited to privilege tiers at each layer of the system. Developers can write program scripts that are fed into the interpreter, or fed into the compiler to produce binaries.

Before the user can access this shell interface, the input subsystem needs to be available. The user may have a keyboard or mouse connected to the system that must be enumerated, before the shell interface would be usable. Certain headless systems may not even have video chipsets, but may still run a headless operating system 10. For these embedded platforms, there's a serial or UART interface available that would allow developers to write software for these devices as well.

In this case, the boot process, and shell are made available. However, there is no graphical subsystem to produce a local session on the local monitor. The user may remotely access headless systems and even the CLI over serial. Thus, it is the case that the total installed operating system is very slim. Part of the input module depends on the serial module and would allow for this to occur. Other than that, the system supports remote VNC, Shell sessions, and remote input over VNC that must also be supported by the input subsystem.

When user authentication is required, the user is expected to demonstrate that they have system-level permissions. This can be by typing the system password, or biometric, and might be supplemented requiring a USB flash drive or wireless device. The system is using a random salt to seed the SHA-256 hash of the user's password, or another saved fingerprint. The ‘auth’ subsystem also provides a keyring that is protected in memory. The keyring provides a place for the user to store named public/private key pairs for various applications that use cryptography.

A program could generate an RSA keypair, and store that keypair inside a password-protected keyring on the disk that only gets loaded into memory when needed. The application can specify that the keyring password must be different for a particular application. Developers can specify that an application's storage should be unlockable with the user's account password, or with a separate supplied credential, if the user wants to make the encryption different for some of their apps but not others. The user might want to password protect apps themselves, which will encrypt the application sandbox to a key stored in the user keyring.

The security module is the part of the system that ensures kernel security and integrity by monitoring system calls, looking for calls, including native application program interface calls that are in violation of a strict set of policies. Many features in the operating system 10 require cryptography. While programs may have their own cryptographic implementations, the operating system 10 provides many common algorithms ranging from hashing algorithms like MD5 (legacy), SHA, and Blowfish, to common symmetric and asymmetric encryption ciphers. (AES, RSA, DSA, Elgamel, Diffe-hellman, and other schemes). It also provides access to encryption schemes like Password-based Key Derivation Function (PBKDF1 and PBKDF2). The crypt library's main purpose is to provide known-good implementations of common cryptographic algorithms. These implementations should be peer-reviewed and export an easy-to-use interface for society.

The native crypto library provides both Secure Random Number Generation (SRNG) techniques, such has quadratic residue generation, that can be used for cryptography, and PRNG (Pseudorandom Number Generation) techniques, that are used when the user just wants a random number. Part of this process involves entropy generation, accumulating the microstate of the hardware, and continually running it through a mathematical trap-door or hashing function, and then using it in a progressive modulus division where the output is fed back into the next iteration. The Blum Blum Shub algorithm may be used as a source of unpredictable values when seeded with prime numbers, and the remainder of each iteration is fed into the next iteration (e.g., quadratic residue). Finally, virtualization support is critical to the graphical components of the operating system functioning correctly. In short, the virtualization module is used to abstract the virtualization capabilities of the CPU and depends on the ‘cpu’ modules having already been started. Extended processor features like Intel's VT-x and AMD-V are abstracted into a single system where blocks of instructions can be scheduled onto the processor to be run as part of the hypervisor without making different calls for VT-x or AMD-V.

The hypervisor uses a process known as ‘context switching’ to quickly change between scheduled work from the HVWS VMs. It would appear that multiple workspaces are running at the same time, when in actuality, the hypervised is just switching between them very quickly, taking into account execution priority as it does. Multi-threaded processes do run blocks concurrently, which means that the hypervisor can schedule additional work to be executed simultaneously. However, some processors have many processor cores, and some mainboards have multiple CPU sockets. There may be possibility to divide the workload by making multiple instances of the program, or by splitting sections of an execution schedule for each workspace into blocks of instructions to be concurrently processed. The hypervisor facilitates context switching by maintaining states from each execution block, so that the next time a relevant block is processed, execution can resume from and build upon the state of the previous block execution.

The ‘video’ and ‘sound’ modules also provide enhanced hardware acceleration capabilities. Vendors write hardmods and sysmods for their video and audio hardware, which are then detected by the ‘video’ and ‘sound’ modules. The hardmods provides a hardware space driver for audio and video hardware, and sysmods provide system space services that provide an abstraction to the driver hardmod for the hypervisor. Certain drivers might permit the resource to be shared between workspaces, and others might require that the hardware be directly exposed to the hypervisor. This means that these devices can be accessed through native application program interface calls, or natively with a guest driver, and are abstracted this way in order to provide the most functionality for dedicated graphics and audio hardware. It depends upon the hardware and drivers.

The radio module implements a common understanding of radio protocols like 802.11 (WiFi) and 802.15 (Bluetooth), whereas the ‘net’ and ‘socket’ modules allow for network communication all together. However, the radio module provides a WiFi and Bluetooth interface to the layers above, which is particularly useful to developers and network engineers, as they have the ability to debug the network stack. Certain parts of the API are used to create TCP or UDP sockets, including privileges required in order to open raw sockets, which would provide the ability to collect network traffic from other programs on the system. The opened socket itself is an object that is usable from inside the application sandbox.

Native application program interface commands are scheduled onto the hypervisor, broken down into threads, and executed on the underlying hardware, where the hardware and system space modules run the privileged or non-privileged operations. Technically, this breaks outside of the virtualization sandbox, but allows guests to run with full hardware acceleration from inside the sandbox. The system's arbiters are responsible for deciding whether or not to allow NAPI calls.

Depending on domain policy and user privileges, the arbiter will deny, delay, or execute native calls. Apps can do whatever they want inside the sandbox, but as soon as they request native resources, or make native calls that leave the sandbox, the arbiter will verify the transaction or block with the user. The security module audits the event as a grant or denial. This makes the data easily available to protection software. An antimalware solution could use chains of events and search for similar execution patterns to find malicious behaviors. Users are encouraged to create domains and created shared domain resources. The mesh protocol provides a way for nodes to share computing resources with one another after pairing. The operating system 10 can create domain resources where the resource is actually split amongst multiple machines.

Machines can pair when two devices are on, and one user does the flip gesture towards the other user's device. Users hold their device so that it is facing the neighboring user's device, and take turns performing a flip gesture or flick of the wrist. The amount of time between flicks on either device are made into a timeline. The difference in timing either user's flick is compared against a threshold value for a legitimate pair gesture, and the devices validate keypair, saving the trusted fingerprints to a database. Flip pair gestures may be witnessed by neighboring devices of wireless, and device may validate neighboring device's transactions by logging that keys were trusted or escrowed to further mitigate issues with web-of-trust issues. In a distributed domain, witnessed security transactions may be persisted on multiple domain machines, so that a domain ledger of security transactions can be made consistent among machines. Users can verify that the codes on the screen are the same, and may be asked to compare key fingerprints, or simply choose to trust based on a correlative complexity threshold. That is, how likely the pairing parties intended to pair based on the observed values. Under the hood, this is a cryptographic key exchange that occurs where an asymmetric algorithm is used to establish a temporal session key that the two devices will use to share data. Public-key certificates are stored in the authentication store after a successful pair.

If a user allows for pairing over the Internet, cryptographic sessions can be formed on-the-fly from trusted certificates in the trust store. The difference is that traffic can traverse the Internet as well as the mesh network to get to its destination. There is no expectation that machines have to participate in mesh traffic forwarding, but it is enabled automatically for explicitly defined domains, such that the system administrators can choose a portion of resources to contribute to the domain, and domain files and resources, will be shared across those machines. The users may need to manually verify their key fingerprints or use a trusted 3rd party to maintain copies of each user's public keys in relation to individual device fingerprints.

The system space is a part of the kernel 30 where the hardware-to-virtualization abstractions occur, and where system services live. A system service is a process that starts on its own schedule and runs in the background as a specific non-hardware user. They are often invoked upon boot, although this is not required. System space has many sysmods (system modules) that export virtual hardware for the hypervisor. Hardware can be assigned or shared between workspaces in the Virtual Configuration Manager. With a virtual space virtmod, the abstracted hardware can be utilized by a hypervisor or hypervised workspace.

System space also has antivirus and firewall services that scan for malicious files and control the rules in the lower parts of the stack in hardware space. For this the software may also have hardware or boot modules. The antivirus has an advantage that it sits outside of the sandbox and can scan entire workspaces whether they are turned on or off. Workspace data may be stored as encrypted flat files on the disk, in which case, the data may not be scannable while the VM is at rest. Changing the default firewall rulesets via native API calls, or from a system space module, may cause the antivirus process to trigger a hardware space confirmation dialog. However, users can choose to allow the addition of a trusted services. Trusted services are allowed to access certain hardware space whenever they need, but the user must re-authenticate at the time of installation, and a trusted signing authority has to have verified the integrity of the module.

Users can install unsigned modules, and in one implementation, must wait for a 15 second countdown timer on the screen warning them that the installation of the unsigned modules could completely destroy their system. Once the module has been tested by a trusted authority and signed, the system will treat it has safe without this additional warning. Implicit trust may come via the web-of-trust or a Nebula domain ledger.

The service configuration remembers the SHA256 checksums for each service's binary and will not run the service if the checksum changes. That being said, the service installation process will uninstall previous services with the same name, and each time the service binary is updated by the vendor, the checksum changes to match the new binary. If the service updates into an unsigned binary, then re-authentication would be required, otherwise that service can update itself automatically. The requirements are that trusted services must be signed by the vendor, installed after the user confirms the hardware space dialog from the arbiter, and can be removed or configured not to start at boot, at any time.

The default abstractions for antivirus and firewall are extended by developers who wish to make their own antivirus products. Developers can choose to extend the antivirus and firewall APIs and build their own antimalware software, or other software that requires constant hardware permissions to run. This means that the user can choose to install 3rd party antivirus solutions and other privileged software, but they must re-authenticate with the system in order to acknowledge the developer's stated reasons for the inclusion of each capability and show a brief summary of the program's expected behavior. The security process might use these summarized breakdowns to audit system processes, terminating or suspending any that are not following the manifest's expected capabilities.

System space has many native methods for developers to use in their programs. Before events are executed, the events travel from the caller (a Hypervised Workspace VM) to the virtual space native application program interface (NAPI) bus. Workspaces dispatch NAPI events onto the bus, and arbiters react by dispatching events to subscribed modules at each privilege tier or ring. A NAPI subsystem 42 itself will subscribe to these events and handle their execution in many in separate threads (e.g., a configurable number). If there is load-balancing enabled, some events may not take precedence over others. There may also be an execution delay imposed, which means the system will wait to act on events for a set period of time. This gives the system administrator the ability to intercept system calls as they are happening, even though the calls are really just delayed by a preconfigured timeout period. A program might try and open a TCP socket in order to communicate on the web, but with an execution delay imposed, certain events will be executed after the delay for debugging purposes. Instead of attaching a separate debugger, a user might decide to inspect the execution of a process by slowing down the execution of system calls with a delay timer. For example, the program may execute at a fraction of the speed, which allows the user to react to the program's execution and pan through recent scheduled blocks of system calls and events on an execution timeline.

Some system calls result in the need for a direct communication with the caller. For example, if the user opens a file, a file handle is returned by the API method, and must be asynchronously accessed as a hypervised resource. Hypervised resources are like virtual hardware resources, except that they account for specific regions of virtual memory where the execution takes place. This means that Hypervised Workspaces gain the full performance of the underlying hardware, because after dispatching native execution events onto the NAPI Bus 46, the calling program can work with the created objects and resources in memory from inside the hypervisor.

System modules 38 lay at the system space layer 18, and are very similar to hardware modules in hardware space layer 16. System space modules 44 exist to provide a bridge between hardmod drivers and the hypervisor. These modules define virtual hardware resources that can be assigned to one or more workspaces. This way the vendor also has control of how their hardware interacts with the hypervisor, which provides the best performance and experience to the user.

From the workspace perspective of hypervised model, the virtual hardware resources appear as physical hardware. In actuality, the hardmods and sysmods provide an abstraction useful to categorically divide resources. Virtmods provide an abstracted virtual resource, to the system space layer, which can utilize resources from custom hardware drivers, and effect changes with the user's own permissions, all the way down to the booting layers. However, with privilege tiers divided as such, access to the booting layers requires that the user re-authenticate in a dialog which may be outside the sandbox itself, so that nothing inside the sandbox can manipulate the user's decision or simulate input into the dialog. Exported virtual device objects let the hypervisor identify new types of hardware that users can assign to each virtual machine. They also handle interaction with the driver for each device in terms of the hypervisor. This means that installed drivers will need to open up native end-points for hardware, which lets the hypervisor gain full hardware acceleration, and handle context switching appropriately.

The audio subsystem provides an abstraction for hardware audio devices on the system and includes an interface for playing audio snippets and streaming audio. It includes a more general understanding of audio hardware, and exports virtual hardware that can be attached to specific workspaces in order to provide audio support. Depending on the user's hardware and driver configuration, the sysmod will either export its functionality through the generic audio interface, which will show up as a ‘Generic Audio Adapter’ or will export the exact hardware signature, so it would appear to the guest as physical vendor hardware.

The ‘serial’ module is used for mounting serial devices onto Hypervised Workspaces. Some workspace users may have older serial devices that would be connected to the COM ports, and there are some advanced users who might be trying to serial into a switch, in order to configure it for their job. The main task for any sysmod is to export a virtual hardware 50 device to the hypervisor. This could happen for many purposes, but in this case, the serial ports on the physical hardware need to be virtualize. The serial abstraction provides an embedded timer and a baud rate for use is serial communications including GPIO console access.

The shared module gives users the ability to share folders with the virtual machine. Other virtualization software has this feature, and the approach taken in is meant to be as trivial as possible, also more reliable. That being said, the ‘shared’ sysmod still provides virtual hardware resources to Hypervised Workspaces. Resources can be attached to the workspace as a named filesystem with a custom unique identifier.

With respect to the disk modules, each hypervised workspace can have one or more hard drives. These drives could be virtual IDE and SATA disks that are saved in a flat-file drive format, or entire physical disks to be mounted inside specific workspaces. In the former case, the user has the option to specify which interface or controller to use for the disk. The user might choose IDE, SATA, or SCSI in order to optimize compatibility with the guest operating system, or there may be hardware passthrough drivers written for the drive controller. When a workspace is powered on, the virtual drive is exposed to the virtual BIOS, and the hypervised workspace boots, the hypervisor will request hardware access to an entire resource, which could include an entire disk or controller of disks, which may result in an entire physical disk array being exposed to the hypervisor for use in workspaces. It also allows attaching hard disk drives and solid-state drives with a software write-block imposed. This makes hypervised workspaces useful for forensic investigations and protects the integrity of disks that should not be altered by the software. The underlying operating system should also be programmed to not automatically mount or run any software on hard disks, and optionally allow for the manual opening and closing of filesystem. This is so that the user understands that the last mount time is updated when the user clicks open. This way, the user won't fear accidentally mounting their drives, which may tamper with any original evidence of that drive. Users have the option to encrypt virtual disks at the virtualization level. This means that the flat-file or physically mounted drives would remain encrypted, and that recording data would require the AES256 encryption keys of the disk. If the user has just typed the password, it is encrypted and held in memory by the system keyring and is unavailable to other programs. An authentication method would include typing a passphrase, entering a biometric from the system's biometric authentication provider, or via device presence. Essentially bringing the operating system-style boot encryption with wireless device support, to virtual machine technology. The system might simulate keystroke input into a virtual machine, here again, from outside the sandbox. In the case of device presence, the user might have to keep their phone nearby, and may also be required to type their password before the workspace will boot, restore from hibernation, or resume state.

The CDROM module is used to mount physical CDROM drives inside hypervised workspaces. Virtual machines can wholly consume the hardware resource or create and share a single virtual resource. A user might share a DVD-RW drive with the guest operating system in order to write backups to a DVD-ROM. Another user might mount a disk image such as an ISO 9660 or ISO 13346 (UDF) encoded image inside the virtual drive. Besides ISO and UDF support, the module should also support raw disk images. The module should support the reverse operating of producing ISO files from CD and DVD ROMs. This is especially because older physical mediums like CD-ROM and DVD-ROM are lower capacity and being phased out of existence due to Internet streaming. Users who wish to convert non-DRM protected disks, or data backups, can export ISO images with the GUI.

The ‘gpu’ module provides a default abstraction and implementation of standard video hardware. When no specific drivers are available for the video card, the system can still render in a limited video mode and feed it to the hypervisor as a “Generic Video Adapter” with 16 MB or 32 MB or otherwise limited video memory. Proprietary drivers can extend this module in order to better expose the features of video hardware to the hypervisor. It means that the vendors can ship similar drivers for guests' operating systems as physical hosts. The ‘gpu’ system module, and modules that inherit from it, must implement a specific set of methods, and export virtual video hardware devices that the hypervisor can attach to workspaces. The hardware signature of the device does not need to match the physical hardware but is the same as the underlying video card by default.

The USB module give users the ability to attach specific USB devices to their workspaces. The default operating system HVWS (the default GUI) has all of the system's devices attached to it, except for the devices that the system did not have modules for. This is because a default installation of the operating system would only have one guest operating system running, an instance of the Nebula Workspace. The user has the option to create additional workspaces and assign individual devices to them or resources from a pool of allocated resources. The user can also auto-assign new devices based on a ruleset filter that chooses common values for known virtualizable platforms.

The ‘state’ module provides access to a wealth of sensors, ACPI, BIOS, and EFI states that many devices have. For example, the system might be installed on a device that has an accelerometer or some other sensors. The device might have temperature sensors, ambient light, human presence, and other kinds of sensors that would be useful to apps inside the sandbox. Some machine exposes certain power states from the BIOS level to the operating system. If the user presses the power button on their laptop, guest operating systems should be able to respond to this event too. To give a better example, the device might be battery operated, and the user working in the workspace might not notice that their battery had been drained, unless the power states have been exposed to the virtual machine. This abstraction is useful for programs that make NAPI calls, because it allows applications to acquire sensor state data from both inside and outside of the workstation.

The Network Interface Card (NIC) module provides an abstraction for both wired and wireless networking hardware. As in other virtualization systems, it lets administrators assign network cards to specific workspaces. Here again, this can occur in two major modes.

The first is the virtual level. When the user attached a NIC to a virtual machine in ‘bridged’ mode, the card is shared between the workspace and the guest like a bus. The machine is exposed alongside the guest on the network, and it is as if the ethernet cable connected both the host and guest at the same time. These cards appear as generic interfaces of several types and use highly compatible drivers that most operating systems already have. Unless a custom sysmod and driver was written for the guest, the hardware would show up as a generic Ethernet or WiFi adapter, which is often all that is needed. These drivers are meant to enumerate a wide range of devices.

The second mode is physical enumeration. Just as the hypervisor can consume entire physical hard drives, it can do this with other hardware such as a network interface card (NIC). The difference is that the card is solely owned by the workspace, and exposed it at a low-level, requiring the hardware vendor's drivers to be installed on the guest OS. A better driver would perform context switching or advanced features of the hardware for the system and virtual layers. This means that all of the features of the card will be available to the user.

An advanced option in either mode, is to specify the VLAN number that traffic exiting the hypervisor should be tagged with. Even though two machines might be on the same Ethernet segment, the VLAN numbers provide a logical separation that is similar to subnetworks. Hosts will ignore traffic from VLANs other than the one that the host is currently on. Users can use the Virtual Configuration Manager to create advanced network configurations, and a virtual network for guest virtual machines. This takes the power of VLANs to the next level with a graphical routing interface that lets the user flow traffic from one NIC and VLAN onto another.

The RAM module allows the user to specify sizable chunks of memory to apply to each workspace. If the user has 8 GB of memory total, that user might allocate a set number of MB to each machine. When this happens the RAM module allocates the memory and handles reads/writes from the hypervisor. Sane defaults and memory limits prevent overuse of system memory that would result in crashes. It is possible to specify the maximum amount of memory for each virtual machine, but execution will pause if the workspace VM is running out of memory within a certain threshold. The same concept applies for full hard disks. If a required resource runs out, or meets threshold, the execution pauses until the user frees disk space, or memory.

From the kernel perspective, any programs that try and write to sections of memory zoned to a virtualized workspace (to the hypervisor) will be denied. Sections of memory are zoned by the kernel to model its sandboxed memory. Nothing in system space should write to memory zoned for hardware space, or a virtualization sandbox. Even between running programs, if a program's tries to read outside of its allocated memory ranges, it will be terminated, which also triggers a security event.

The system also needs to have modules that handle keyboard and mouse input. Although there is already a USB interface that would work for many pointing and typing devices, users should be able to select which device is mapped to specific workspaces. The goal of this module is to be seamless. When the user hits Ctrl-Alt-Right/Left to switch between workspaces, the default keyboard and mouse should be mapped to the workspace that is in the foreground. If the workspace is windowed, then input should be routed to it when the window has focus, that is, when the user switches to it.

There are many kinds of HIDs, and they may also present a danger. The user should always have access to a list of every HID on the system and receive notifications when a HID is plugged and unplugged. Certain recent hacks have involved repurposed phones that register as “Human Input Devices,” but actually collect keystrokes under the hood. This is a privacy violation and security risk to the user. The correct path forward is to log the existence of HIDs and increase their visibility. However, support must still exist for users wishing to use their phone as a keyboard or mouse.

The virtual space layer 20 is where the hypervisor sits. It's also the outer container for the operating system sandbox. Everything that is hypervised is said to be running in the sandbox, even though workspaces are technically separate from each other. A Hypervised Workspace is a type of virtual machine that can have physical hardware attached to it. In some cases, the hypervisor might have to coordinate with the workspace, updating the CPU state or register values, in order to provide physical access to the hardware. Recall that the CPU and GPU communicate with each other over the Front Side Bus.

With respect to the virtual space layer 20, the NAPI bus 46 is a component of a hypervisor 48 that runs asynchronously and accepts NAPI commands from multiple virtual machines at once, and executes them in a load-balanced, or user-specific, ordering. As virtual machines with virtual hardware 50 are running in workspaces (sandbox instances), the hypervisor 48 is constantly context switching, to meet the demands of each instance. The hypervisor 48 will schedule blocks of instructions onto the CPU itself, and acts as a program that quickly switches between virtual machine contexts in order to give the illusion that each virtual machine is running concurrently. Sysmods and hardmods are subscribed to these events, allowing driver vendors to write custom drivers for both the operating system 10, and guest operating systems. When a workspace needs to run applications with native performance, they can schedule execution time with NAPI, which returns a promise of a future resource being available.

A hypervised workspace 52 is a type of virtual machine that has a bus for native execution, and a driver system that allows physical hardware to be exposed to it. When a workspace boots, the system starts up into a virtual BIOS with virtual hardware that forms the basis of the virtual machine as represented by the virtual hardware 50. The hypervised workspace 52 or GUI itself is a special type of hypervised workspace 52 the will either use CPU instruction virtualization features like VT-x and AMD-V, or it will run on the processor natively if processor virtualization technology is not available.

The virtual hardware 50 resources are exposed by system modules and supported by hardware module drivers. Sysmods export hardware that can be used in the hypervisor. In order for the hardware to be valid, the module must export a named piece of hardware that has a vendor code, product code, serial number, and type. The hypervisor 48 breaks the named devices down by type and allocates the hardware into the next free virtual card slot or bus for each workspace that requires the hardware.

As previously discussed, there are two major modes for hardware enumeration: Physical hardware enumeration and Virtual hardware enumeration. Hardware that has been physically enumerated, can be solely dedicated to a single Hypervised Workspace, and requires the vendor's drivers to be installed inside the workspace. Virtually enumerated hardware is hardware that is virtualized, that is, it can be scheduled and shared between multiple workspaces. Whether the device appears as a generic device or uses a driver that was bundled with the guest operating system, a ‘stock driver’, the device can be attached to virtual guests.

With respect to the sandbox layer 28, a workspace sits inside the virtualization sandbox. Multiple workspaces can be running simultaneously, and users can switch between them with the default hotkeys. Users can create additional workspaces, and edit which devices are connected to the workspace with the virtual configuration manager.

An application framework 56 is a part of the workspace or workspaces 54. It is technically a huge API that developers can use to build their own applications. It also defines all of the GUI components for each Apps, which allows developers to build hybrid applications that have both web and native components to get the best user experience and performance. The application framework 56 contains many components related to user experience, diagnostics, rendering, and debugging functionality, while the native API provides a performant solution to interacting with hardware. Workspaces 54 that are unaware of NAPI can continue to running software in a plain virtualization mode, but guest drivers and software that understand NAPI gives the operating system users a way to interact with the operating system from other operating systems.

One important part of building an app, is ensuring that it doesn't have a bunch of bugs. As with other compilers, the native Pythonic compiler understands the difference between DEBUG and RELEASE modes, and will insert include a debugging symbols table, when apps are built with debug mode turned on. The debugging table give developers the ability to jump to the exact line number of the offending part of the program, and the system debugger tracks changes in memory in order to report the values of individual variables.

Besides all of the features that one would typically see, such as, performance graphs, debug levels, and the values of variables, memory locations, and CPU features. The use would also be able to intercept NAPI calls (native system calls) in order to discover the source of a problem.

In one use case, the developer might add a delay to NAPI, which means that any system calls made, are purposely delayed before execution. This gives the developer time to see what is occurring in in slow motion. In an ordinary circumstance, the NAPI calls would have been executed in a fraction of a second, but with NAPI delay turned on, the developer can use the graphical user interface to watch programs as they are being executed, and the results of each call, as results are returned. This is possible because the application framework is nested inside the virtual machine container, and from the perspective of the VM, events are still being executed in sequential order. (causal time) However, from the perspective of the developer, these calls are scheduled, displayed on the screen, and are executed after the delay timer reaches zero. To make this better, there are columns for each thread that the application starts, which further allows the developer to visualize NAPI calls that would ordinarily be executed in parallel. The developer can locate the exact thread that made the offending NAPI call(s), set a breakpoint, and make edits to the program at that precise spot.

Applications 58 are supposed to be really easy to build, which is why common web languages were chosen as the default for building GUIs in Nebula. Anyone who understands HTML and CSS, should be able to start building a GUI for their app, and anyone who understands Python, should be able to pick up the native app language.

Developers can write apps that use the application framework and native APIs without worrying about changing their compilation toolchain, because the native and non-native API calls are both made in the same compiled Pythonic language. The application framework is divided into both native and non-native calls to make it apparent which calls are happening outside of the sandbox, and which calls are being made inside the sandbox. The separation allows developers to choose and get the most benefit out of the APIs combined.

As for privileged calls, most of these calls are native because most privileges involve making requests outside the application sandbox. For example, the developer might open a socket with the application framework, and then go and open a RAW socket with the native API. The socket opened inside the sandbox can only interact with information coming in/out of the sandbox, the native socket is privileged, and can intercept traffic coming out of the underlying machine. This kind of functionality would trigger re-authentication before the system would allow it.

Another example, is that the application framework lets developers write applications that create files within the application sandbox, otherwise calls can be made to the native framework that would allow for low-level disk access and drive selection beneath the hypervisor. This means that developers have the option to control the entire underlying operating system from inside the virtual machine sandbox itself but that auditing occurs beneath the virtual layer, and neighboring machines on the domain may help to validate or witness security transactions in a domain ledger.

In terms of security, the integrity of the underlying operating system relies on the authentication subsystem. As hypervised workspaces make native calls, or certain privileged calls, the system's arbiters handle events going across the NAPI Bus and will allow or deny individual calls. The Security Manager keeps logs of patterns of system calls in order to detect malicious patterns. That way, even if the user does allow a malicious program, and mistakenly re-authenticates, there is a second line of defense within the API itself that will recognize malicious patterns of system calls. Calls and patterns of calls can be persisted in the event chain for extra security, and to provide a complete execution trail for each workstation utilizing the operating system 10.

The operating system 10 may have a web engine 60 and a certificate store 62. The certificate store 62 is where the operating system keeps PKI certificates related to TLS/SSL (websites) and network-level signatures. This provides a way for the operating system to verify the connection authenticity of remote hosts. One aspect of the operating system 10 is its ability for hosts to distribute resources among member machines, and for machines to elect a leader in a peer-to-peer topology as part of a distributed system. One feature involves asking the rest of the domain if the certificate is a domain certificate, and how many machines agree that the certificate is legitimate. Since the operating system domains are not geography locked, hosts can be anywhere in the world, which provides the domain with additional perspectives about any given server's cryptographic signatures.

To give an example of this, one operating system host has an outdated certificate store, and is wrongly forming TLS connections with a remote server. After joining the domain, the machine will ask the other machines in the domain about the validity of the same TLS/SSL certificate, and will find that its valid status had been revoked by a trusted authority. This is one great benefit of joining a domain, machines will collaborate together in order to take preventive security countermeasures and react to security issues. This means that the security of an individual machine is not only computed from the perspective of the system, but also from neighboring machines around that machine. That is, machines may share an audit trail by creating a signable ledger for each domain and may use the principles of fault-tolerance from algorithms like RAFT and PhaseKing to maintain the integrity of the ledger can withstand manipulation. Each machine may vote about the authenticity of the blocks of events based on policy criteria. Fault-Tolerance and redundancy can be used to, for example, make it so that up to a third of the total machines on the domain would need to become compromised in order make alterations to the global domain ledger of security events, and swing the distributed consensus vote in the attacker's favor. Machines may vote that posed data does not match actual physical events, or the network may come to consensus that blocks of data were not valid. Finally, a machine may exhibit a behavior that ⅔rds of the network does not exhibit as seen on a reporting machine's chain. Voting on blocks of events in a distributed or fault-tolerant fashion creates a logging infrastructure that is resistant to manipulation when weighed against the other machines on the domain. The technique can be used to provide Byzantium Security, which helps to isolate infected machines by their behaviors from the rest of the voting domain of machines and helps to enforce that machines must follow the logical rules and policies of the domain. In order to participate in deciding the validity of security transactions, a machine's domain client must also vote predictably when neighboring machines pose elections. If a machine begins to vote in favor of a policy that ⅔ of the network has agreed to ignore or begins to violate any permanent rulesets or policies, the network may consider that the domain software implementation or security status of that machine is outlying to the rest of the network. In order to participate on the Nebula domain, hosts must pass logical election challenges based on policy to validate that each host implementation is allowed to participate in elections.

A package manager 64 allows users to install applications found in both a store-like interface or by hand. In either case, the user is shown a summary of what is to be installed or removed before each transaction. If the app contains an unsigned service, the user will answer a re-authentication dialog. The package manager 64 keeps track of each application's permission requirements and has an API for breaking installed applications down by their permission categories. The API has methods that make it really easy to spot malware, and aides the user in identifying apps that have more privileges/access than needed.

Each application has a JSON metadata associated with it that is returned as a Pythonic dictionary for compiled or interpreted programs accessing the API. Users can write scripts to install programs or build compiled software tools for working with package metadata. The packages and metadata are signed by the package distributor and repository. This forms a public-key infrastructure between developers and the repositories pushing their software.

System administrators can subscribe to additional repositories, which makes software from those repositories installable in both the CLI and GUI and adds the repository's public-key certificates to the system certificate store. Domain policy might forbid adding additional repositories or may specify a single domain repository.

A native framework 66 is a major component of the application framework 56. It is separate because the native framework 66 involves transactions that work outside of the sandboxed area, that are used to run the operating system 10 from inside the sandbox. In terms of permissions required, to interact with NAPI the operating system 10 demands that each application or ‘app’ demonstrate user, system, or hardware privileges, depending on the situation. In each case, users may perform many transactions for opening files, TCP sockets, and querying information from services. However, making edits to the hypervisor 48, controlling the running status of other workspaces, opening RAW sockets, putting network interface cards in monitor mode, and controlling the running status of system services, requires system-level privileges. Altering anything in hardware space requires prior authorization. Users are not meant to log in as the Hardware User, but it is possible if the user answers a low-level re-authentication dialog and demonstrates hardware ownership. Typically, this would not happen unless the system could not boot into a graphical session. (for debugging)

Apps can be granted continual NAPI access through services. Services are a system space concept, for a continually running background process, that may or may not start with the computer. In order to make privileged NAPI calls, the system must have the user re-authenticate, and their user account must be marked with system or hardware privileges. In either case, the user might start the app as a normal user, and then answer a re-authentication dialog generated by system/hardware arbiters, before being granted access to a greater privilege tier.

Users can create sockets, mutexes, and modify owned files. Users can also modify permissions on owned resources, mount external/removable media, and view running processes and open sockets, view firewall rules and domain policies, and collaborate with domain users. In general, can perform most common tasks on the system. There is a healthy amount of having users answer dialogs for security reasons, which is a must.

A system space tier allows users to alter firewall rules and access more parts of the filesystem related to system space, ownership of files owned by basic user accounts, opening raw sockets with the ability to monitor network traffic, add/removing trusted certificates, and installing system modules or extensions. Hardware users can install low-level drivers for hardware, install hardware modules, view or clear logs about devices that have ever been plugged into the system, access every file on the system except for those that reside in boot space. Boot permissions may be used to change the encryption keys of the primary volume, change the boot menu to include new operating system entries, replace the bootloader, swap the default kernel, add cryptographic modules, or to switch sources of entropy. The separation makes it so that requests need to go through an arbiter for execution at a lower-layer.

In one embodiment, the goal is to follow the least privilege philosophy, while providing as many features to normal users as possible. Most users will find everything they need with a standard user account, including the ability to create their own hypervised workspaces 52, based on the resources that have been allocated to them by a system administrator. System administrators can manage user accounts, take ownership of normal user's workspaces and files. Administrators can control most aspects of the system that would not break the installation or allow for permanent persistence of malware. Ordinary users are allowed to install apps bundled with services, provided those services are signed.

Unsigned services require authorization by a system user or administrator, re-authentication, and timed countdown before the install can be granted. This is to warn the person that the program will try and start at boot prevent a bot from clicking ‘okay’ on the dialog, or by simulating keyboard input with a software HID. Furthermore, NAPI commands, and the execution of the querying program is blocked until the user grants or denies the dialog and request. This prevents malicious developers from using low-level dialogs to distract the user from being able to stop another NAPI transaction. Imagine if a dialog popped up, and meanwhile the program was sending your files to another computer, all while you were deciding whether to grant access in the first place. This is why the dialogs cannot be clicked from inside the sandbox.

With respect to the applications 58, ‘Apps’ are programs that run in the operating system sandbox by default and may escalate privileges into system or hardware space with the permission of a system or hardware user, and one or more security demonstrations. Stock apps include applications that every desktop operating system typically has, like a calculator, file-browser, terminal, clock, image viewer, media player, audio recorder, flashlight app, AM/FM radio, screenshot tool, and otherwise. These applications 58 are all bundled with the operating system and take up very little resources. Stock apps follow the same rules as normal applications, except that they cannot be uninstalled without system privileges. Stock apps are not meant to be removed by ordinary users, as they are core to the operating system experience, and critical services. For example, if the user were to uninstall the default software keyboard, they might be unable to type on a touchscreen device and would be required to use a keyboard. It might not sound critical, but the intention is to prevent the user from uninstalling software that the system has to have. However, the NAPI API is lower level and provides a line of defense against bundled apps. There have been problems in industry regarding applications that come bundled with devices. The sensor, camera, microphone and certain other physical hardware are accessible with NAPI calls from inside the sandbox, but the user may choose to block calls from the entire sandbox. Some guests may have APIs for contacts, photos and user data that reside within the sandbox.

These apps 58 are all core to the operating system 10 experience and displayed alongside other applications that the user has installed. If the user has system permissions, they should be able to remove these applications, and swap them out for others. However, the requirement of administrator permissions it justified, because users might remove their terminal or file browser, which would present a problem. However, users can spin up new hypervised workspaces 52 in order to get these apps 58 back, as they are found inside the sandbox. If the user were to break the graphical components of the operating system 10 with system-level permissions, then those components would need to be reinstalled from the hardware space command interpreter.

Hypervised workspaces 52 are a concept similar to a virtual machine, except with a native bus 46 and interfaces for running low-level operating system operations. A system space arbiter 53 and the hardware space arbiter 41 intercept NAPI events as they flow across the BUS in order to ask the user for re-authentication or check the context is correct for the commands to be run. That is, more generally, each of the native interfaces as represented by the native framework 66, system space arbiter 53, the hardware space arbiter 41, and the boot mode arbiter 27, as appropriate, are configured to intercept the dispatched event for authentication and context check. Workspaces 54 represent sandboxed components of the operating system 10 with the graphical user interfaces, application framework, and software keyboard.

Hypervised workspaces 52 are different from virtual machines because they include a native interface for controlling the entire underlying operating system. NAPI allows users to authenticate inside the sandbox in order to control the operating system underneath. The NAPI commands are broken up by tier in order to provide the most granularity and permissions options for users. Normal user accounts without system or hardware tier privilege endorsements, can't run any NAPI commands that would break the system, or pose a privacy risk to other users. For example, the user could install tasks that run on a schedule, but not system services, as those start at boot, and will affect other users of the system.

The hypervisor 48 has a BUS called the NAPI Bus 46, which accepts NAPI system calls from workspaces that dispatch NAPI events onto the bus. The events are processed asynchronously by the lower layers of the operating system, and the result is returned to the requesting program after the API call has been executed. These calls are translated by the system and hardware space modules into low-level functionality and logged by the Security Manager hardmod. When a synchronous resource is requested, the result of the call might be allocated in memory or file descriptor and handle opened that the calling workspace can use to perform operations outside of the sandbox. Whether these native operations are privileged or not, the resource is allocated and exposed to the hypervisor 48 and workspace. The calling program, running nested inside the workspace, can work with the resource through the native framework 66 at speed. This means that certain hardware devices and software that cannot be virtualized, can be wholly consumed by a workspace. Hardware or software components that support scheduling, or the sharing of resources between workspaces, can be exposed to the hypervisor attached to multiple workspaces simultaneously.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. An operating system for a computing system, the operating system comprising:
a hypervisor having a hypervised workspace and a native interface to control an underlying portion of the operating system including a system space having a native application program interface and a hardware space, the hypervised workspace providing an emulation of a portion of the computing system;
the native interface including a bus accepting a call from the hypervised workspace and dispatching an event for processing;
the native interface performing an initial authentication of the dispatched event within the hypervised workspace;
a system space arbiter interposed between the hypervised workspace and the system space, the system space arbiter configured to intercept the dispatched events for authentication and context checks; and
a hardware space arbiter interposed between the system space and the hardware space, the hardware space arbiter configured to intercept the dispatched events for authentication and context checks.

2. The operating system as recited in claim 1, further comprising at least one common operating system installed, without dual-booting, alongside the operating system.

3. The operating system as recited in claim 1, wherein the native interface and the bus run low-level operating system operations.

4. The operating system as recited in claim 1, wherein the emulation of the portion of the computing system includes a graphical user interface, an application framework, and a software keyboard.

5. The operating system as recited in claim 1, wherein the dispatched events are processed asynchronously by lower layers of the operating system.

6. The operating system as recited in claim 1, wherein the computing system comprises a system selected from the group consisting of desktops, laptops, and mobile hardware systems.

7. The operating system as recited in claim 1, wherein the bus further comprises a component of the hypervisor that runs asynchronously and accepts native application program interface commands from multiple virtual machines at once and executes in a load-balanced ordering.

8. An operating system for a computing system, the operating system comprising:
a hypervisor having a hypervised workspace and a native interface to control an underlying portion of the operating system including a system space having a native application program interface and a hardware space, the hypervised workspace providing an emulation of a portion of the computing system;
the native interface including a bus accepting a call from the hypervised workspace and dispatching an event for processing, the call being broken up by tier with respect to system and hardware privileges;
the native interface performing an initial authentication of the dispatched events within the hypervised workspace;
a system space arbiter interposed between the hypervised workspace and the system space, the system space arbiter configured to intercept the dispatched events for authentication and context checks; and
a hardware space arbiter interposed between the system space and the hardware space, the hardware space arbiter configured to intercept the dispatched events for authentication and context checks.

9. The operating system as recited in claim 8, further comprising at least one common operating system installed, without dual-booting, alongside the operating system.

10. The operating system as recited in claim 8, wherein the native interface and the bus run low-level operating system operations.

11. The operating system as recited in claim 8, wherein the emulation of the portion of the computing system includes a graphical user interface, an application framework, and a software keyboard.

12. The operating system as recited in claim 8, wherein the dispatched event is processed asynchronously by lower layers of the operating system.

13. The operating system as recited in claim 8, wherein the computing system comprises a system selected from the group consisting of desktops, laptops, and mobile hardware systems.

14. The operating system as recited in claim 8, wherein the bus further comprises a component of the hypervisor that runs asynchronously, and accepts native application program interface commands from multiple virtual machines at once, and executes in a load-balanced ordering.

15. An operating system for a computing system, the operating system comprising:
a hypervisor having a hypervised workspace and a native interface to control an underlying portion of the operating system including a system space having a native application program interface and a hardware space, the hypervised workspace providing an emulation of a portion of the computing system, the emulation of the portion of the computing system includes a graphical user interface, an application framework, and a software keyboard;
the native interface including a bus accepting a call from the hypervised workspace and dispatching an event for processing, the call being broken up by tier with respect to system and hardware privileges;
the native interface performing an initial authentication of the dispatched event within the hypervised workspace;
a system space arbiter interposed between the hypervised workspace and the system space, the system space arbiter configured to intercept the dispatched event for authentication; and
a hardware space arbiter interposed between the system space and the hardware space, the hardware space arbiter configured to intercept the dispatched event for authentication.

16. The operating system as recited in claim 15, further comprising at least one common operating system installed, without dual-booting, alongside the operating system.

17. The operating system as recited in claim 15, wherein the native interface and the bus run low-level operating system operations.

18. The operating system as recited in claim 15, wherein the dispatched event is processed asynchronously by lower layers of the operating system.

19. The operating system as recited in claim 15, wherein the computing system comprises a system selected from the group consisting of desktops, laptops, and mobile hardware systems.

20. The operating system as recited in claim 15, wherein the bus further comprises a component of the hypervisor that runs asynchronously and accepts native application program interface commands from multiple virtual machines at once to execute in a load-balanced ordering.
